(19) United States
(12) Patent Application Publication
(10) Pub. No.: US 2026/0287920 A1
(43) Pub. Date: Sep. 24, 2026

(54) DISPLAY DEVICE

(71) Applicant: InnoLux Corporation, Miao-Li County (TW)

(72) Inventors: Chih-Chin KUO, Miao-Li County (TW); Jin Yi TAN, Miao-Li County (TW); Ying-Jen CHEN, Miao-Li County (TW)

(73) Assignee: InnoLux Corporation, Miao-Li County (TW)

(21) Appl. No.: 19/398,098

(22) Filed: Nov. 24, 2025

Related U.S. Application Data
(60) Provisional application No. 63/774,753, filed on Mar. 20, 2025.

(30) Foreign Application Priority Data
Sep. 5, 2025 (CN) 202511264681.7

(51) Int. Cl. G02B 30/28; G02F 1/1335; G02F 1/13363; G02F 1/1343; G02F 1/1347

(52) U.S. Cl. CPC G02B 30/28; G02F 1/133528; G02F 1/13363; G02F 1/134309; G02F 1/1347

(57) ABSTRACT

A display device capable of displaying two dimensional images or three dimensional images according to display requirements includes a display used to provide a display image, wherein the display includes a first polarizing unit, and the first polarizing unit has a first polarizing direction; a second polarizing unit disposed on the first polarizing unit and having a second polarizing direction; a polarization switching unit disposed on the second polarizing unit and including a polarization switching medium, wherein a polarization state of the polarization switching medium can be changed by switching voltage; and a lens array disposed on the second polarizing unit. An included angle is between the first polarizing direction and the second polarizing direction, and the included angle ranges from 5 to 20 degrees.

### CROSS REFERENCE TO RELATED APPLICATION

This application claims the benefit of U.S. Provisional Application No. 63/774,753, filed on Mar. 20th, 2025. The content of the application is incorporated herein by reference.

### BACKGROUND OF THE DISCLOSURE

### 1. Field of the Disclosure

The present disclosure relates to a display device, and more particularly to a display device capable of switching between 2D display and 3D display.

### 2. Description of the Prior Art

As user demands for display devices increase, to enable a display device to display both two-dimensional and three-dimensional images through structural design of the display device is still an important issue in the present field.

### SUMMARY OF THE DISCLOSURE

The present disclosure aims at providing a display device capable of switching between 2D display and 3D display.

An embodiment of the present disclosure provides a display device capable of displaying two dimensional images or three dimensional images according to display requirements. The display device includes a display used to provide a display image, wherein the display includes a first polarizing unit, and the first polarizing unit has a first polarizing direction; a second polarizing unit disposed on the first polarizing unit and having a second polarizing direction; a polarization switching unit disposed on the second polarizing unit and including a polarization switching medium, wherein a polarization state of the polarization switching medium can be changed by switching voltage; and a lens array disposed on the second polarizing unit. An included angle is between the first polarizing direction and the second polarizing direction, and the included angle ranges from 5 to 20 degrees.

An embodiment of the present disclosure provides a display device capable of displaying two dimensional images or three dimensional images according to display requirements. The display device includes a display used to provide a display image; a quarter-wave plate disposed on the display; a linear polarizer disposed on the quarter-wave plate, wherein the linear polarizer has a first polarizing direction; a polarization switching unit disposed on the linear polarizer and including a polarization switching medium, wherein a polarization state of the polarization switching medium can be changed by switching voltage; and a lens array disposed on the linear polarizer and having an optical axis extending in a first direction. The first polarizing direction is parallel to the first direction.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a cross-sectional view of an electronic device according to a first embodiment of the present disclosure.

FIG. 2 schematically illustrates a cross-sectional view of an electronic device according to a first embodiment of the present disclosure.

FIG. 3 schematically illustrates a cross-sectional view of an electronic device according to a second embodiment of the present disclosure.

FIG. 4 schematically illustrates a cross-sectional view of an electronic device according to a variant embodiment of the second embodiment of the present disclosure.

FIG. 5 schematically illustrates a cross-sectional view of an electronic device according to another variant embodiment of the second embodiment of the present disclosure.

FIG. 6 schematically illustrates a cross-sectional view of an electronic device according to a third embodiment of the present disclosure.

FIG. 7 schematically illustrates a cross-sectional view of an electronic device according to a fourth embodiment of the present disclosure.

FIG. 8 schematically illustrates a cross-sectional view of an electronic device according to a fifth embodiment of the present disclosure.

FIG. 9 schematically illustrates a cross-sectional view of an electronic device according to a fifth embodiment of the present disclosure.

FIG. 10 schematically illustrates a cross-sectional view of an electronic device according to a sixth embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the device, and certain elements in various drawings may not be drawn to scale. In addition, the number and dimension of each element shown in drawings are only illustrative and are not intended to limit the scope of the present disclosure.

Certain terms are used throughout the description and following claims to refer to particular elements. As one skilled in the art will understand, electronic equipment manufacturers may refer to an element by different names. This document does not intend to distinguish between elements that differ in name but not function.

In the following description and in the claims, the terms “include”, “comprise” and “have” are used in an open-ended fashion, and thus should be interpreted to mean “include, but not limited to...”.

When an element or layer is referred to as being “disposed on” or “connected to” another element or layer, it can be directly on or directly connected to the other element or layer, or intervening elements or layers may be presented (indirectly). In contrast, when an element is referred to as being “directly on” or “directly connected to” another element or layer, there are no intervening elements or layers presented. When an element or a layer is referred to as being “electrically connected” to another element or layer, it can be a direct electrical connection or an indirect electrical connection. The electrical connection or coupling described in the present disclosure may refer to a direct connection or an indirect connection. In the case of a direct connection, the ends of the elements on two circuits are directly connected or connected to each other by a conductor segment. In the case of an indirect connection, switches, diodes, capacitors, inductors, resistors, other suitable elements or combinations of the above elements may be included between the ends of the elements on two circuits, but not limited thereto.

Although terms such as first, second, third, etc., may be used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

According to the present disclosure, the thickness, length and width may be measured through optical microscope, and the thickness or width may be measured through the cross-sectional view in the electron microscope, but not limited thereto.

In addition, any two values or directions used for comparison may have certain errors. In addition, the terms “equal to”, “equal”, “the same”, “approximately” or “substantially” are generally interpreted as being within ± 10%, ± 5%, ± 3%, ± 2%, ± 1%, or ± 0.5% of the given value.

In addition, the terms “the given range is from a first value to a second value” or “the given range is located between a first value and a second value” represents that the given range includes the first value, the second value and other values there between.

If a first direction is said to be perpendicular to a second direction, the included angle between the first direction and the second direction may be located between 80 to 100 degrees. If a first direction is said to be parallel to a second direction, the included angle between the first direction and the second direction may be located between 0 to 10 degrees.

Unless it is additionally defined, all terms (including technical and scientific terms) used herein have the same meaning as commonly understood by those ordinary skilled in the art. It can be understood that these terms that are defined in commonly used dictionaries should be interpreted as having meanings consistent with the relevant art and the background or content of the present disclosure, and should not be interpreted in an idealized or overly formal manner, unless it is specifically defined in the embodiments of the present disclosure.

It should be noted that the technical features in different embodiments described in the following can be replaced, recombined, or mixed with one another to constitute another embodiment without departing from the spirit of the present disclosure.

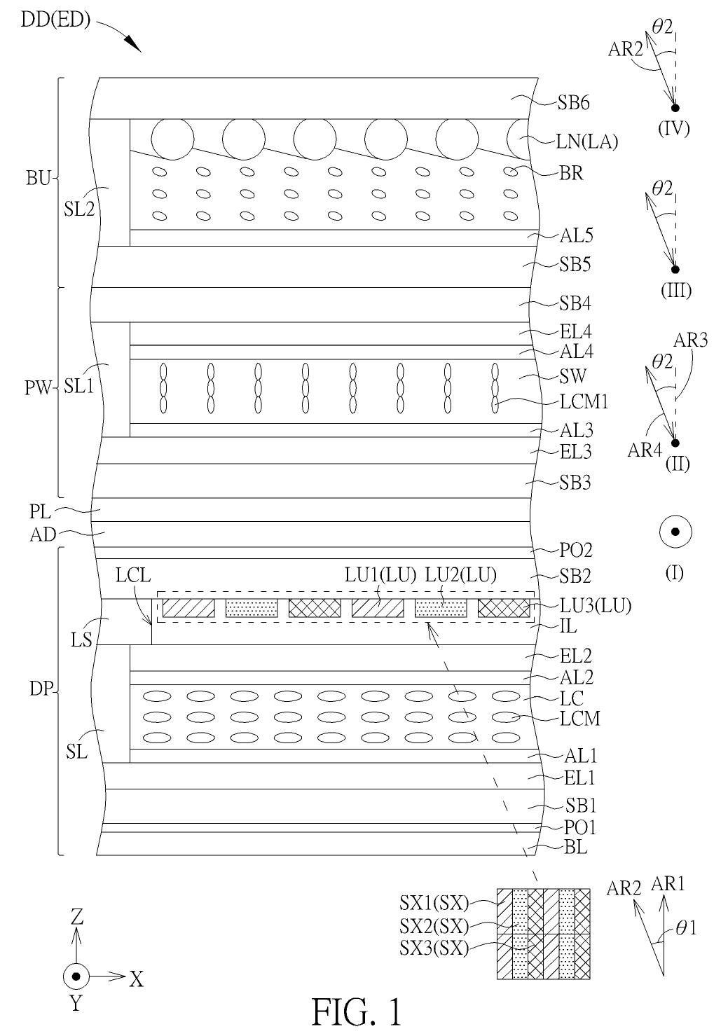

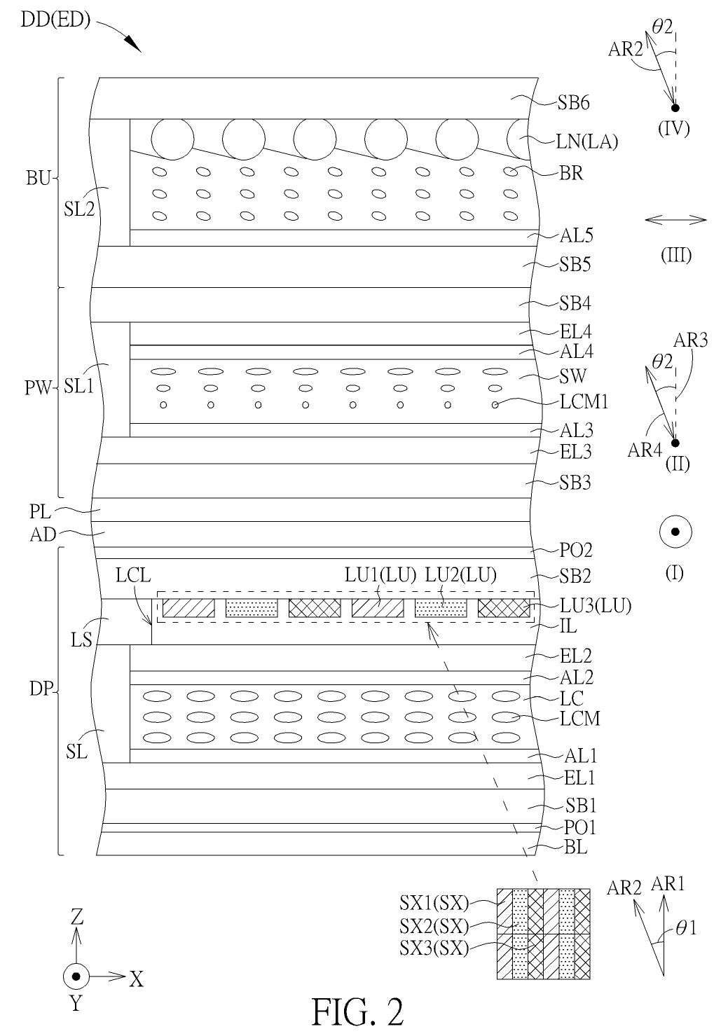

Referring to FIGS. 1 and 2, FIGS. 1 and 2 schematically illustrate a cross-sectional view of an electronic device according to a first embodiment of the present disclosure. Specifically, FIGS. 1 and 2 respectively illustrate the electronic device ED in different display states. The electronic device ED of the present disclosure may include a display device DD, but not limited thereto. In some embodiments, the electronic device ED may include a combination of the display device DD and other types of devices. According to the present embodiment, the display device DD may include a display DP, a polarizing unit PL, a polarization switching unit PW, a birefringent unit BU and a lens array LA, but not limited thereto. The polarizing unit PL is disposed on the display DP. The polarization switching unit PW is disposed on the polarizing unit PL. The birefringent unit BU is disposed on the polarization switching unit PW. In the present embodiment, the lens array LA may be disposed in the birefringent unit BU, but not limited thereto. In other words, the lens array LA is disposed on the polarizing unit PL and also on the polarization switching unit PW. The structures of the elements or layers in the display device DD will be described in detail below.

The display DP of the present embodiment may include a non-self-emissive display device. For example, the display DP may include any suitable type of liquid crystal display panel, but not limited thereto. Specifically, as shown in FIG. 1, the display DP may include a substrate SB1 and a substrate SB2. The substrate SB1 and the substrate SB2 may include rigid materials or flexible materials. The rigid materials may include glass, quartz, sapphire, ceramics, other suitable materials, or combinations thereof. The flexible materials may include polyimide (PI), polycarbonate (PC), polyethylene terephthalate (PET), cellulose triacetate (TAC), other suitable materials, or combinations thereof. In some embodiments, the substrate SB1 and the substrate SB2 may include any suitable adhesive material, such as optical clear adhesive (OCA). The substrate SB1 and the substrate SB2 may include any suitable transparent material or high-transmittance material, such that light may pass through the substrate SB1 and the substrate SB2 without being blocked or absorbed. Although the substrate SB1 and the substrate SB2 shown in FIG. 1 are illustrated as single-layer structures, the present disclosure is not limited thereto. In some embodiments, the substrate SB1 and the substrate SB2 may each include a multilayer structure.

The display DP further includes an alignment layer AL1, a liquid crystal layer LC and an alignment layer AL2 disposed between the substrate SB1 and the substrate SB2. The liquid crystal layer LC is disposed adjacent to the alignment layer AL1 and the alignment layer AL2. Specifically, the liquid crystal layer LC may be sandwiched between the alignment layer AL1 and the alignment layer AL2. The liquid crystal layer LC may include liquid crystal molecules LCM. The alignment layer AL1 and the alignment layer AL2 may align the liquid crystal molecules LCM in a specific direction. The alignment layer AL1 and the alignment layer AL2 may include polyimide, polyamide (PAA), other suitable materials, or combinations thereof. The alignment directions of the alignment layer AL1 and the alignment layer AL2 may be formed, for example, by rubbing alignment, photo-alignment, or other suitable methods.

The display DP further includes an electrode EL1 and an electrode EL2 disposed between the substrate SB1 and the substrate SB2. In the present embodiment, the electrode EL1 may be disposed between the alignment layer AL1 and the substrate SB1, and the electrode EL2 may be disposed between the alignment layer AL2 and the substrate SB2. One of the electrode EL1 and the electrode EL2 may serve as a pixel electrode, and the other may serve as a common electrode. For example, the electrode EL1 may serve as the pixel electrode, while the electrode EL2 may serve as the common electrode, to which a common voltage may be applied. In this case, when no voltage is applied to the electrode EL1, no electric field is generated between the electrode EL1 and the electrode EL2. When a voltage is applied to the electrode EL1, an electric field is generated between the electrode EL1 and the electrode EL2, thereby causing the liquid crystal molecules LCM to rotate and change their arrangement. The electrode EL1 and the electrode EL2 may include any suitable conductive material, such as transparent conductive materials. It should be noted that although it is not shown in FIG. 1, the display DP may further include a circuit layer disposed between the electrode EL1 and the substrate SB1. The circuit layer may for example provide electrical signals to the electrode EL1 to control the rotation of the liquid crystal molecules LCM.

The display DP may further include a light shielding layer LS and a light conversion layer LCL disposed between the substrate SB1 and the substrate SB2. For example, the light shielding layer LS and the light conversion layer LCL may be disposed between the substrate SB2 and the electrode EL2. Specifically, the light conversion layer LCL may include a plurality of light conversion units LU and an insulating layer IL surrounding the plurality of light conversion units LU. The insulating layer IL may separate the plurality of light conversion units LU. In other embodiments, the light conversion layer LCL may include the light conversion units LU and a black matrix layer located between adjacent light conversion units LU. In this case, the black matrix layer may replace the insulating layer IL. The light conversion units LU may include any suitable material capable of changing the wavelength or color of light passing therethrough. For example, the light conversion units LU may include color filters, quantum dots, phosphors, other suitable materials, or combinations thereof. In the present embodiment, the light conversion units LU in the light conversion layer LCL may include a first light conversion unit LU1, a second light conversion unit LU2, and a third light conversion unit LU3, wherein the first light conversion unit LU1, the second light conversion unit LU2 and the third light conversion unit LU3 may be used to convert light (e.g., light emitted from the backlight module BL) into light of different colors. For example, the first light conversion unit LU1 may convert light into red light, the second light conversion unit LU2 may convert light into green light, and the third light conversion unit LU3 may convert light into blue light, but not limited thereto. In some embodiments, the first light conversion unit LU1, the second light conversion unit LU2 and the third light conversion unit LU3 may be used to convert light into the same color. The insulating layer IL may include any suitable insulating material. The light shielding layer LS may be disposed adjacent to the light conversion layer LCL and may include any suitable light shielding material. In the present embodiment, the display DP may include a plurality of sub-pixels SX, each of which may be defined by one light conversion unit LU. Specifically, one light conversion unit LU and the corresponding portion of the liquid crystal layer LC may be regarded as one sub-pixel. In this case, the sub-pixel SX defined by the first light conversion unit LU1 may be a first sub-pixel SX1, which may be a red sub-pixel; the sub-pixel SX defined by the second light conversion unit LU2 may be a second sub-pixel SX2, which may be a green sub-pixel; and the sub-pixel SX defined by the third light conversion unit LU3 may be a third sub-pixel SX3, which may be a blue sub-pixel. The first sub-pixel SX1, the second sub-pixel SX2, and the third sub-pixel SX3 may form one pixel, but not limited thereto.

The display DP further includes a sealant SL disposed between the substrate SB1 and the substrate SB2. Specifically, the sealant SL may be disposed along the outer edge of the display DP and define a disposition space of the liquid crystal layer LC. Alternatively, the sealant SL may be disposed to prevent leakage of the liquid crystal layer LC.

The display DP further includes a polarizing unit PO1 and a polarizing unit PO2. The polarizing unit PO1 may be disposed on the side of the substrate SB1 opposite to the substrate SB2, i.e., below the substrate SB1, while the polarizing unit PO2 may be disposed on the side of the substrate SB2 opposite to the substrate SB1, i.e., above the substrate SB2. The polarizing unit PO1 and the polarizing unit PO2 may include polarizers, but not limited thereto. The display DP further includes a backlight module BL disposed on the side of the substrate SB1 opposite to the substrate SB2. For example, the backlight module BL may be disposed below the polarizing unit PO1, but not limited thereto. The backlight module BL may include a light source for providing the light required for image display by the display DP. Although it is not shown in FIG. 1, the backlight module BL may further include elements applicable to the backlight module BL, such as a light guide plate, a diffusion plate, and the like.

It should be noted that the disposition positions of the elements or layers in the display DP shown in FIG. 1 is merely exemplary and is not limited in the present embodiment. In addition, the display DP may include other suitable elements or layers and is not limited to the structure shown in FIG. 1.

According to the present embodiment, the polarization switching unit PW disposed on the display DP may include a substrate SB3, a substrate SB4, and an electrode EL3, an alignment layer AL3, a polarization switching medium SW, an alignment layer AL4, and an electrode EL4 disposed between the substrate SB3 and the substrate SB4, but not limited thereto. The electrode EL3 is located on the substrate SB3, the electrode EL4 is located on the electrode EL3, the substrate SB4 is located on the electrode EL4, and the polarization switching medium SW is located between the electrode EL3 and the electrode EL4. Specifically, the electrode EL3 may be disposed between the alignment layer AL3 and the substrate SB3, and the electrode EL4 may be disposed between the alignment layer AL4 and the substrate SB4. The polarization switching medium SW may be disposed adjacent to the alignment layer AL3 and the alignment layer AL4. Specifically, the polarization switching medium SW may be sandwiched between the alignment layer AL3 and the alignment layer AL4. The materials of the substrate SB3 and the substrate SB4 may refer to the materials of the substrate SB1 and the substrate SB2 mentioned above. The materials of the alignment layer AL3 and the alignment layer AL4 may refer to the materials of the alignment layer AL1 and the alignment layer AL2 mentioned above. The materials of the electrode EL3 and the electrode EL4 may refer to the materials of the electrode EL1 and the electrode EL2 mentioned above. The polarization state of the polarization switching medium SW may be changed by switching voltage. In other words, the polarization switching medium SW may be used to change the polarization state (or polarizing direction) of light passing therethrough. The polarization switching medium SW may include any suitable liquid crystal material. For example, in the present embodiment, the polarization switching medium SW may include liquid crystal molecules LCM1, which may be twisted nematic (TN) liquid crystals, but not limited thereto. In other words, the polarization switching unit PW may for example include a twisted nematic liquid crystal cell. In this case, the alignment direction of the alignment layer AL3 may be perpendicular to the alignment direction of the alignment layer AL4, but not limited thereto. As shown in FIG. 1, the polarization switching unit PW may further include a sealant SL1 disposed between the substrate SB3 and the substrate SB4. The sealant SL1 may be disposed along the outer edge of the polarization switching unit PW to define a disposition space of the polarization switching medium SW or prevent leakage of the polarization switching medium SW. According to the present embodiment, the polarization switching unit PW may be used to switch the polarization state (or polarizing direction) of light. Specifically, when a light (i.e., light emitted from the backlight module BL) passes through the polarization switching unit PW, the polarization state (or polarizing direction) of the light may be changed or maintained by the polarization switching medium SW, thereby achieving the effect of switching the polarization state (or polarizing direction) of the light. In detail, in an embodiment (e.g., where the polarization switching medium SW includes twisted nematic liquid crystals), when an electric field is generated between the electrode EL3 and the electrode EL4, the liquid crystal molecules LCM1 in the polarization switching medium SW may rotate and align substantially perpendicular to the substrate (e.g., substrate SB3), such that the light passing through the polarization switching medium SW maintains its original polarization state (or polarizing direction). When no electric field is generated between the electrodes EL3 and EL4, the liquid crystal molecules LCM1 in the polarization switching medium SW may maintain their original alignment and change the polarization state (or polarizing direction) of the light passing through the polarization switching medium SW, for example, by rotating the polarizing direction of the light by 90 degrees. Alternatively, in another embodiment, when an electric field is generated between the electrode EL3 and the electrode EL4, the light passing through the polarization switching medium SW may change its polarization state (or polarizing direction); and when no electric field is generated between the electrode EL3 and the electrode EL4, the light passing through the polarization switching medium SW may maintain its original polarization state (or polarizing direction). Therefore, by changing the voltage applied to the polarization switching unit PW, the polarization state (or polarizing direction) of the light passing through the polarization switching unit PW can be switched. It should be noted that the polarization switching unit PW of the present embodiment may further include other suitable elements or layers and is not limited to the structure shown in FIG. 1.

According to the present embodiment, the birefringent unit BU disposed on the polarization switching unit PW may include a substrate SB5, a substrate SB6, an alignment layer AL5 and a birefringent material BR. The substrate SB5 is located on the polarization switching unit PW, the substrate SB6 is located on the substrate SB5, and the alignment layer AL5 and the birefringent material BR are disposed between the substrate SB5 and the substrate SB6. Specifically, the alignment layer AL5 may be disposed on the substrate SB5, and the birefringent material BR may be disposed adjacent to and on the alignment layer AL5. The materials of the substrate SB5 and the substrate SB6 may refer to the materials of the substrate SB1 and the substrate SB2 mentioned above. The material of the alignment layer AL5 may refer to the materials of the alignment layer AL1 and the alignment layer AL2 mentioned above. In the present embodiment, the birefringent material BR may include a liquid crystal material, but not limited thereto. As shown in FIG. 1, the birefringent unit BU may further include a sealant SL2 disposed between the substrate SB5 and the substrate SB6. The sealant SL2 may be disposed along the outer edge of the birefringent unit BU to define a disposition space of the birefringent material BR or to prevent leakage of the birefringent material BR. In the present embodiment, the lens array LA may be disposed in the birefringent unit BU. Specifically, the lens array LA may be disposed at any suitable position on the birefringent material BR. For example, the lens array LA may be disposed between the substrate SB6 and the birefringent material BR, but not limited thereto. The lens array LA may include a plurality of lens units LN, or in other words, the lens array LA may be formed by arranging a plurality of lens units LN in a matrix. The lens units LN may have a cylindrical shape, but not limited thereto. In some embodiments, the lens units LN may be disposed on the substrate SB6 to form the lens array LA, and then the substrate SB6 may be assembled with the substrate SB5 to form the birefringent unit BU. At least one of the refractive indexes (including the ordinary refractive index and the extraordinary refractive index) of the birefringent material BR may be equal to the refractive index of the lens array LA (or the lens units LN in the lens array LA). According to the present embodiment, when light enters the birefringent material BR, if the polarizing direction of the light is parallel to the extending direction of the optical axis of the lens array LA (or the lens units LN), the light may pass through the lens units LN without refraction. In this case, the light exiting the lens array LA may be used to display a two-dimensional (2D) image. On the other hand, if the polarizing direction of the light is not parallel to the extending direction of the optical axis of the lens array LA (or the lens units LN), the light may be refracted when entering the lens units LN. In this case, the light exiting the lens array LA may be used to display a three-dimensional (3D) image. Therefore, the display device DD may display either a 2D or 3D image, or in other words, the display device DD may be switched between a 2D display mode and a 3D display mode. In brief, through the above structural design, the polarizing direction of a polarized light emitted from the display DP (i.e., the light passing through the polarizing unit PO2) may be changed or maintained after passing through the polarization switching unit PW, making the polarizing direction of the polarized light parallel or not parallel to the extending direction of the optical axis of the lens units LN when the polarized light enters the lens array LA, thereby achieving the effect of displaying either a 2D or 3D image. In some embodiments, the polarizing direction of the polarized light emitted from the display DP may be changed to be parallel to the extending direction of the optical axis of the lens units LN or remain unchanged to be not parallel to the extending direction of the optical axis of the lens units LN after passing through the polarization switching unit PW. In some embodiments, the polarizing direction of the polarized light emitted from the display DP may be changed to be not parallel to the extending direction of the optical axis of the lens units LN or remain unchanged to be parallel to the extending direction of the optical axis of the lens units LN after passing through the polarization switching unit PW.

According to the present embodiment, the extending direction of the lens units LN in the lens array LA may be not parallel to the arrangement direction of the sub-pixels SX in the display DP. The extending direction of the lens units LN may for example be the extending direction of the side surface of the cylindrical shape of the lens units LN, or in other words, the direction from a bottom surface to the other bottom surface. FIG. 1 exemplarily shows the extending directions of the sub-pixels SX and the lens units LN. Specifically, as shown in FIG. 1, when the display device DD is viewed from a top view, the sub-pixels SX in the display DP may extend along a direction AR1, and the lens units LN may extend along a direction AR2, wherein the direction AR1 may be not parallel to the direction AR2. In the present embodiment, an included angle θ1 may be between the direction AR1 and the direction AR2, wherein the included angle θ1 may range from 5 to 20 degrees, but not limited thereto. The included angle θ1 may for example represent the degree of rotation of the extending direction of the lens units LN relative to the arrangement direction of the sub-pixels SX. The above-mentioned direction AR1 may refer to one of the multiple extending directions of the sub-pixels SX. For example, in the present embodiment, the sub-pixels SX may extend along both the direction X and the direction Y and be arranged in a matrix, as shown in FIG. 1. It should be noted that the arrangement of the sub-pixels SX shown in FIG. 1 is a schematic view observed in the normal direction (i.e., the direction Z) of the display device DD. In this case, the direction AR1 mentioned above may be the direction X or the direction Y. For example, in the present embodiment, the direction AR1 may be the direction Y, and in this case, when the display device DD is viewed from the top, the extending direction AR2 of the lens units LN may be not parallel to the direction Y, and the included angle θ1 may be between the extending direction AR2 and the direction Y. In some embodiments, the extending direction AR2 of the lens units LN may be not parallel to the direction X, and the included angle θ1 may be between the extending direction AR2 and the direction X. It should be noted that the extending direction of the lens units LN (i.e., the direction AR2) may also be the extending direction of the optical axis of the lens units LN. In other words, the extending direction of the optical axis of the lens units LN is not parallel to the extending direction of the sub-pixels SX (i.e., the direction AR1), and an included angle θ1 is between the extending direction of the optical axis of the lens units LN and the extending direction of the sub-pixels SX. Through the above-mentioned design, the possibility of moiré patterns caused by the extending direction of the lens units LN being parallel to the extending direction of the sub-pixels SX may be reduced, thereby improving the display performance of the display device DD.

In addition, the display device DD further includes the polarizing unit PL disposed on the display DP. The polarizing unit PL may be disposed at any suitable position between the display DP and the polarization switching unit PW. That is, the polarizing unit PL may be disposed on the polarizing unit PO2 of the display DP. In the present embodiment, the polarizing unit PL may be attached to the display DP via an adhesive layer AD, for example, attached to the polarizing unit PO2 of the display DP. The adhesive layer AD may include any suitable transparent adhesive or high-transmittance adhesive material. In addition, although it is not shown in the figure, the display device DD may further include an adhesive layer for attaching the polarizing unit PL to the polarization switching unit PW, but not limited thereto. In an embodiment, the substrate SB3 may include an adhesive material for attaching the polarizing unit PL to the polarization switching unit PW. According to the present embodiment, the polarizing unit PL may have a polarizing direction AR4, which may be parallel to or the same as the extending direction (i.e., the direction AR2) of the lens unit LN (or the optical axis of the lens unit LN). “The polarizing direction AR4 of the polarizing unit PL is parallel to the extending direction (i.e., the direction AR2) of the lens unit LN” mentioned above may represent that the included angle (not shown) between the polarizing direction AR4 and the direction AR2 may range from 0.01 to 3 degrees (i.e., 0.01°<angle<3°). In this case, the polarizing direction AR4 of the polarizing unit PL may not be parallel to the extending direction (i.e., the direction AR1) of the sub-pixels SX, and the included angle θ1 may be between the polarizing direction AR4 and the direction AR1. The polarizing unit PL may include a polarizer, but not limited thereto. In some embodiments, the polarizing unit PL may include a reflective polarizer, such as a direct laminate reflective polarizer (DLRP). The polarization ratio of the polarizing unit PL may be between 70% and 99.9% (i.e., 70%<polarization ratio<99.9%). The light transmittance of the polarizing unit PL may be between 40% and 90% (i.e., 40%<transmittance<90%). Through disposition of the polarizing unit PL and design of polarizing direction of the polarizing unit PL, the display quality of the display device DD in the 2D display mode may be improved, which will be detailed in the following. The operation of the display device DD in the 2D and 3D display modes is described in detail with reference to FIGS. 1 and 2.

FIG. 1 illustrates the structure of the display device DD, the polarization states of light after passing through the layers, and the extending direction of the optical axis of the lens units LN (as shown in states (I)–(IV)) in the 2D display mode. It should be noted that the states (II)–(IV) shown in FIG. 1 are observed in the normal direction (i.e., the direction Z) of the display device DD, that is, the states (II)–(IV) are illustrated on the XY plane. In detail, in the present embodiment, the polarizing unit PO2 disposed on the substrate SB2 in the display DP may have a polarizing direction AR3 (as shown in state (II)), wherein the polarizing direction AR3 may be parallel to the direction Y, but not limited thereto. In this case, the polarizing direction of the polarized light passing through the polarizing unit PO2 may be parallel to the polarizing direction AR3, or in other words, parallel to the direction Y. That is, the polarization state of the polarized light passing through the polarizing unit PO2 may be shown in the state (I) in FIG. 1 (i.e., parallel to the direction Y). In some embodiments, the polarizing unit PO2 may have other polarizing directions. As described above, since the extending direction of the lens unit LN (i.e., the direction AR2) is not parallel to the arrangement direction of the sub-pixels SX, the extending direction of the lens unit LN may not be parallel to the polarizing direction AR3 of the polarizing unit PO2. In this case, since the polarizing direction AR4 of the polarizing unit PL may be parallel to the extending direction of the lens unit LN, the polarizing direction AR4 may not be parallel to the polarizing direction AR3. For example, as shown in state (II) of FIG. 1, an included angle θ2 may be between the polarizing direction AR4 of the polarizing unit PL and the polarizing direction AR3 of the polarizing unit PO2, wherein the included angle θ2 may range from 5 to 20 degrees (i.e., 5°≤θ2≤20°), but not limited thereto. The included angle θ2 may also be regarded as the included angle between the polarizing direction AR3 of the polarizing unit PO2 and the extending direction of the lens unit LN (i.e., the direction AR2). The value of the included angle θ2 may depend on the degree of rotation of the extending direction of the lens unit LN (i.e., the direction AR2) relative to the polarizing direction AR3 of the polarizing unit PO2. For example, the greater the deviation of the extending direction of the lens unit LN from the polarizing direction AR3 of the polarizing unit PO2, the greater the included angle θ2 may be. In the present embodiment, the included angle θ2 may be the same as the included angle θ1 mentioned above, but not limited thereto. In some embodiments, when the arrangement direction of the sub-pixels SX (i.e., the direction AR1) is not parallel to the direction Y, the included angle θ2 may be different from the included angle θ1. Through disposition of the polarizing unit PL, the polarizing direction of light after passing through the polarizing unit PL may be parallel to the polarizing direction AR4 (i.e., rotated by the included angle θ2), or in other words, the polarization state of the light may change from state (I) to state (II). That is, the polarizing unit PL may convert the polarizing direction of light emitted from the display DP into a direction parallel to the extending direction of the optical axis of the lens unit LN.

After a light passes through the polarizing unit PL, the light may enter the polarization switching unit PW. In the present embodiment, as described above, when an electric field is generated between the electrode EL3 and the electrode EL4, the liquid crystal molecules LCM1 in the polarization switching medium SW may rotate and be aligned substantially perpendicular to the substrate (e.g., the substrate SB3), such that the light passing through the polarization switching medium SW may maintain its original polarization state (or polarizing direction). Therefore, the polarization state of the light after passing through the polarization switching unit PW may be shown in the state (III), which is the same as the state (II). That is, the polarizing direction of the light after passing through the polarization switching unit PW may be parallel to the extending direction of the optical axis of the lens unit LN (i.e., the direction AR2). In this case, the polarizing direction of the light entering the birefringent unit BU (or the lens array LA) may be parallel to the extending direction of the optical axis of the lens unit LN. The state (IV) in FIG. 1 illustrates the extending direction of the optical axis of the lens unit LN, that is, the direction AR2. Therefore, the light may pass through the lens array LA without refraction, allowing the display device DD to display 2D images. That is, the display device DD is in the 2D display mode. According to the present embodiment, by disposing the polarizing unit PL between the display DP and the polarization switching unit PW, even if the extending direction of the optical axis of the lens unit LN is not parallel to the polarizing direction of the polarizing unit PO2, the polarizing unit PL may change the polarizing direction of the light before it enters the polarization switching unit PW, such that the polarizing direction of the light becomes parallel to the extending direction of the optical axis of the lens unit LN. Therefore, the display quality of the display device DD in the 2D display mode may be improved while reducing the occurrence of moiré patterns. Specifically, in a comparative embodiment, when the display device DD does not include the polarizing unit PL, the polarizing direction of the light entering the birefringent unit BU (or the lens array LA) may not be parallel to the extending direction of the optical axis of the lens unit LN, which may affect the display quality of the display device DD in the 2D display mode.

On the other hand, as shown in FIG. 2, when no electric field is generated between the electrode EL3 and the electrode EL4 in the polarization switching unit PW, the liquid crystal molecules LCM1 in the polarization switching medium SW may maintain their original alignment and may change the polarization state (or polarizing direction) of the light passing through the polarization switching medium SW. In this case, the polarizing direction of the light may be changed after passing through the polarization switching medium SW. For example, the polarizing direction of the light before entering the polarization switching unit PW may be parallel to the direction AR4 (i.e., the polarizing direction of the polarizing unit PL), and the polarizing direction of the light after passing through the polarization switching unit PW may be parallel to the direction X, but not limited thereto. That is, the polarization state of the light may change from state (II) to state (III) after passing through the polarization switching unit PW. In this case, since the polarizing direction of the light is not parallel to the extending direction of the optical axis of the lens unit LN, the light may be refracted when passing through the lens array LA, thereby displaying 3D images. That is, the display device DD may be in the 3D display mode. Other features shown in FIG. 2 may refer to FIG. 1 and the contents above, and will not be redundantly described.

In brief, by switching the polarization state of the polarization switching unit PW (or the polarization switching medium SW), the polarizing direction of light emitted from the display DP may be parallel or non-parallel to the extending direction of the optical axis of the lens unit LN, thereby enabling the display device DD to display either 2D or 3D images. In some embodiments, the display device DD may be used as a vehicle display. Specifically, the display device DD may be disposed at any suitable position in a vehicle to project its displayed image onto the windshield, wherein the display device DD may display information in either the 2D display mode or the 3D display mode according to user requirements, but not limited thereto.

Other embodiments of the present disclosure will be described in the following. In order to simplify the description, the same layers or elements in the following embodiments would be labeled with the same symbol, and the features thereof will not be redundantly described. The differences between the embodiments will be detailed in the following.

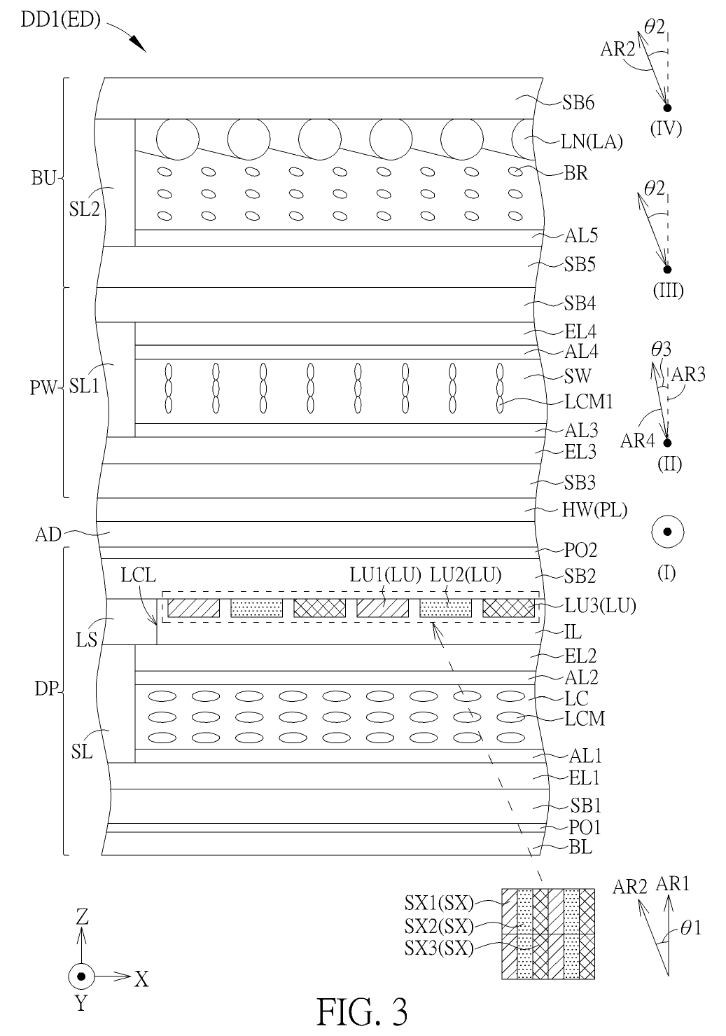

Referring to FIG. 3, FIG. 3 schematically illustrates a cross-sectional view of an electronic device according to a second embodiment of the present disclosure. It should be noted that FIG. 3 illustrates the display device DD1 in the 2D display mode. One of the main differences between the display device DD1 of the present embodiment and the display device DD of the first embodiment described above is the design of the polarizing unit PL. In the present embodiment, the polarizing unit PL of the display device DD1 may include a half-wave plate HW, that is, the display device DD1 includes a half-wave plate HW disposed between the display DP and the polarization switching unit PW. According to the present embodiment, the polarizing direction of the half-wave plate HW (i.e., the polarizing direction AR4 mentioned above) may not be parallel to the polarizing direction (i.e., the polarizing direction AR3 mentioned above) of the polarizing unit PO2 of the display DP, and an included angle θ3 may be between the polarizing direction AR4 and the polarizing direction AR3, as shown in state (II) of FIG. 3. It should be noted that “the polarizing direction of the half-wave plate HW” mentioned above may be defined as the extending direction of the fast axis of the half-wave plate HW. The included angle θ3 may be half of the included angle (that is, the included angle θ2) between the polarizing direction AR3 of the polarizing unit PO2 and the extending direction (i.e., the direction AR2) of the lens unit LN (that is, θ3=1/2θ2).

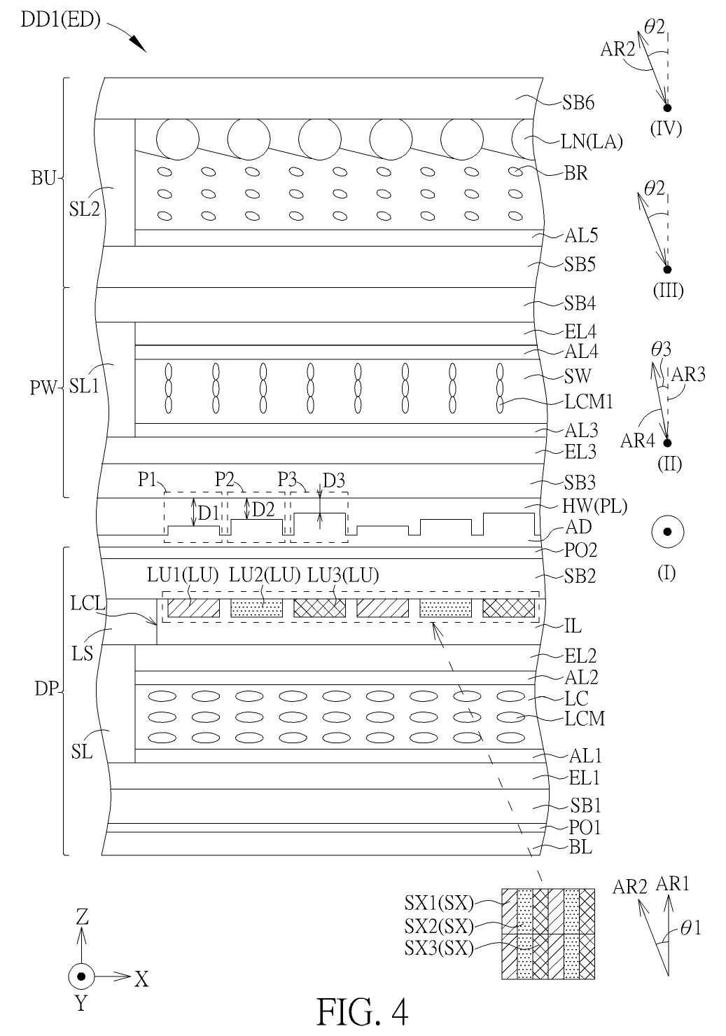

Referring to FIG. 4, FIG. 4 schematically illustrates a cross-sectional view of an electronic device according to a variant embodiment of the second embodiment of the present disclosure. In the present variant embodiment, the half-wave plate HW as the polarizing unit PL may include portions corresponding to different sub-pixels SX, and these portions may have different thicknesses. Specifically, as shown in FIG. 4, the half-wave plate HW may include a portion P1 corresponding to the first sub-pixel SX1 (i.e., the first light conversion unit LU1), a portion P2 corresponding to the second sub-pixel SX2 (i.e., the second light conversion unit LU2), and a portion P3 corresponding to the third sub-pixel SX3 (i.e., the third light conversion unit LU3), wherein the portion P1 may have a thickness D1, the portion P2 may have a thickness D2, the portion P3 may have a thickness D3, and the thickness D1, the thickness D2, and the thickness D3 may be different from each other. According to the present embodiment, the greater the wavelength of the color of the sub-pixel SX, the greater the thickness of the corresponding portion of the half-wave plate HW may be. Through the above-mentioned design, excessive difference between phase retardations of light of sub-pixels of different colors passing through the half-wave plate HW may be reduced, thereby improving the display performance of the display device DD1. Other features shown in FIG. 4 may refer to FIG. 3 and the contents above, and will not be redundantly described.

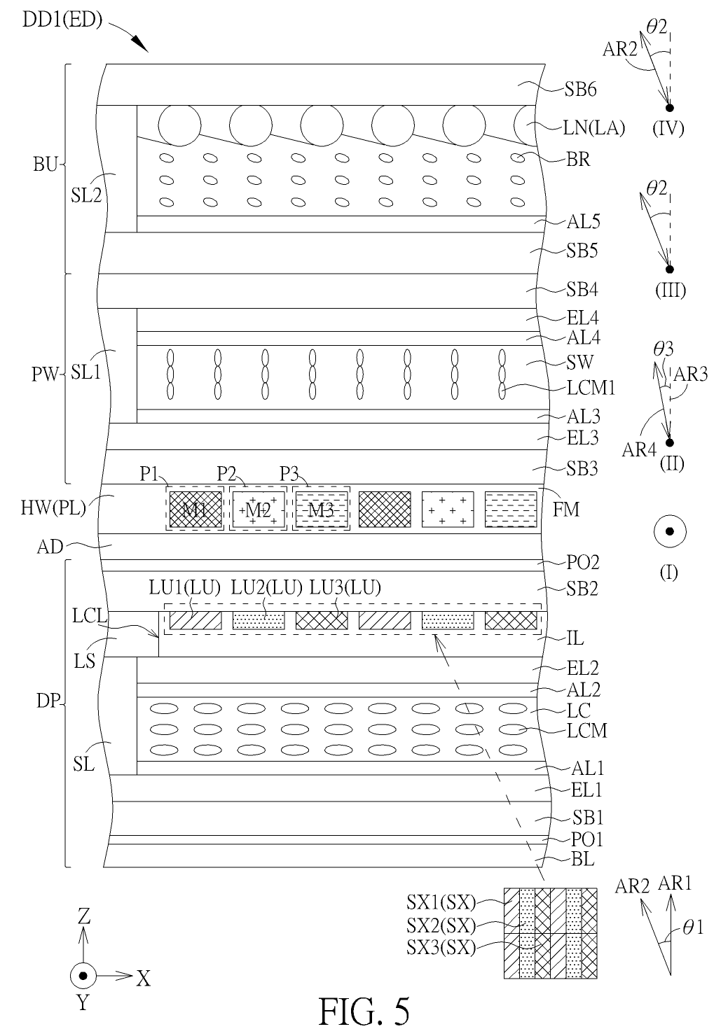

Referring to FIG. 5, FIG. 5 schematically illustrates a cross-sectional view of an electronic device according to another variant embodiment of the second embodiment of the present disclosure. In the present variant embodiment, the half-wave plate HW as the polarizing unit PL may include portions corresponding to different sub-pixels SX, and these portions may have different materials. Specifically, as shown in FIG. 5, the half-wave plate HW may include a portion P1 corresponding to the first sub-pixel SX1, a portion P2 corresponding to the second sub-pixel SX2, and a portion P3 corresponding to the third sub-pixel SX3, wherein the portion P1 may include a first material M1, the portion P2 may include a second material M2, and the portion P3 may include a third material M3, and the first material M1, the second material M2, and the third material M3 may be different wave plate materials, that is, different birefringent materials. According to the present variant embodiment, the greater the wavelength of the color of the sub-pixel SX, the greater the refractive index difference (i.e., Δn, which is the difference between the extraordinary refractive index ne and the ordinary refractive index no) of the material of the corresponding portion of the half-wave plate HW may be. As shown in FIG. 5, the polarizing unit PL may further include a filling material FM, which may encapsulate the first material M1, the second material M2, and the third material M3. The filling material FM may include any suitable transparent insulating material. For example, the filling material FM may include optical adhesive, but not limited thereto. Through the above-mentioned design, excessive difference between phase retardations of light of sub-pixels of different colors passing through the half-wave plate HW may be reduced, thereby improving the display performance of the display device DD1. Other features shown in FIG. 5 may refer to FIG. 3 and the contents above, and will not be redundantly described.

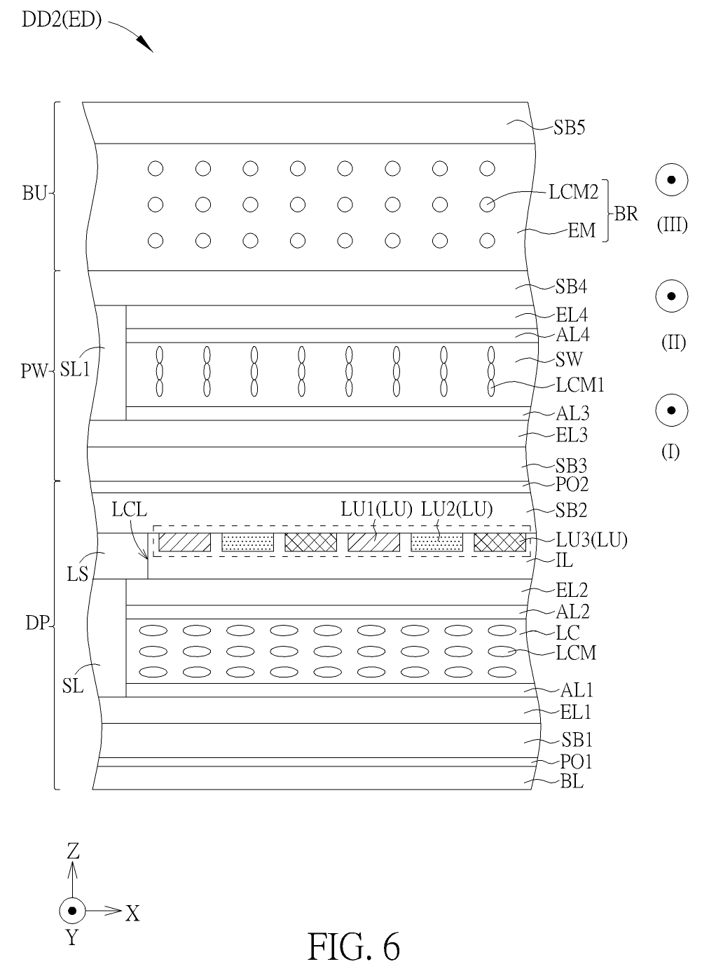

Referring to FIG. 6, FIG. 6 schematically illustrates a cross-sectional view of an electronic device according to a third embodiment of the present disclosure. It should be noted that FIG. 6 illustrates the display device DD2 in the 2D display mode. One of the main differences between the display device DD2 of the present embodiment and the display device DD of the first embodiment described above is the design of the birefringent unit BU. According to the present embodiment, the birefringent unit BU disposed on the polarization switching unit PW may include a birefringent material BR and a substrate SB5 disposed on the birefringent material BR. The birefringent material BR of the present embodiment may include a liquid crystal polymer (LCP) material. Specifically, the birefringent material BR may include an encapsulating material EM and liquid crystal molecules LCM2, wherein the encapsulating material EM may encapsulate the liquid crystal molecules LCM2. The encapsulating material EM may include any suitable photo-curable or thermo-curable material. In addition, the display device DD2 may not include the polarizing unit PL mentioned above. That is, the polarization switching unit PW (or the substrate SB3) may be directly disposed on the display DP (e.g., directly disposed on the polarizing unit PO2).

According to the present embodiment, the polarization switching unit PW may switch the polarization state of light to match or not match the polarization state of the birefringent unit BU (or the liquid crystal molecules LCM2), thereby enabling the display of 2D or 3D images. For example, as shown in FIG. 6, in the present embodiment, the polarizing direction of the polarized light passing through the polarizing unit PO2 may be parallel to the direction Y, that is, the polarization state thereof may be shown in state (I) in FIG. 6. In addition, the polarizing direction of the birefringent material BR (or the liquid crystal molecules LCM2) in the birefringent unit BU may also be parallel to the direction Y, and the polarization state thereof may be shown in state (III) in FIG. 6. It should be noted that in some embodiments, the polarizing direction of the birefringent material BR may not be parallel to (e.g., perpendicular to) the polarizing direction of the polarizing unit PO2, and the light passing through the polarizing unit PO2 may have its polarization state or polarizing direction changed via the polarization switching medium SW to match the polarization state or polarizing direction of the birefringent material BR. Other features shown in FIG. 6 may refer to FIG. 1 and the contents above, and will not be redundantly described.

In some embodiments, the polarization switching unit PW of the display device may include a super-twisted nematic liquid crystal (STN) unit, or the polarization switching medium SW may include super-twisted nematic liquid crystal, but not limited thereto.

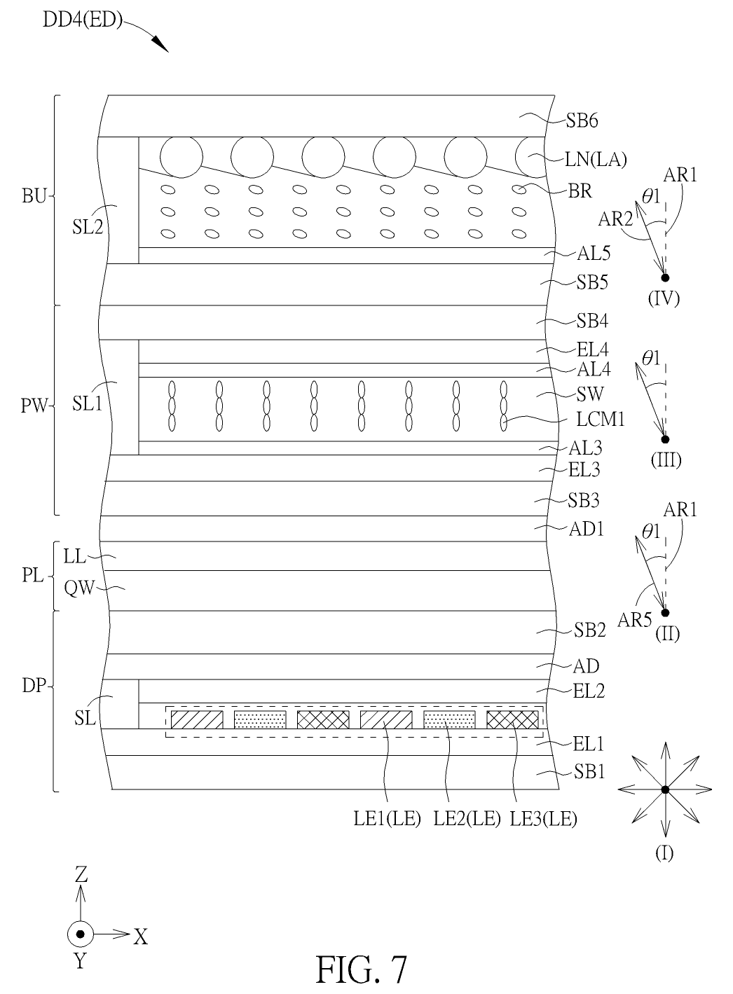

Referring to FIG. 7, FIG. 7 schematically illustrates a cross-sectional view of an electronic device according to a fourth embodiment of the present disclosure. According to the present embodiment, the display DP of the display device DD4 may include a self-emissive display, for example including light emitting diode, but not limited thereto. The light emitting diode may include an inorganic light emitting diode or an organic light emitting diode (OLED). The inorganic light emitting diode may include a micro light emitting diode (micro LED), a mini light emitting diode (mini LED), or a quantum dot light emitting diode (QLED), but not limited thereto. The display DP may include light emitting units LE. In the present embodiment, the light emitting units LE may include a light emitting unit LE1, a light emitting unit LE2, and a light emitting unit LE3, which respectively emit light of different colors. For example, the light emitting unit LE1, the light emitting unit LE2, and the light emitting unit LE3 may respectively emit red, green, and blue light, but not limited thereto. In other embodiments, the light emitting unit LE1, the light emitting unit LE2, and the light emitting unit LE3 may emit light of the same color. The light emitting unit LE may for example include a micro light emitting diode, an organic light emitting diode, other suitable light emitting elements, or combinations thereof. Since the display DP is a self-emissive display, the light emitted from the display DP (or from the light emitting unit LE) may be unpolarized light, and its polarization state may be shown in state (I) in FIG. 7. It should be noted that the structure of the display DP shown in FIG. 7 is merely exemplary, and the elements and layers in the display DP may be arranged or disposed in any suitable manner. The display DP may further include other suitable elements or layers. The polarization switching unit PW may be attached to the polarizing unit PL through an adhesive layer AD1.

According to the present embodiment, the polarizing unit PL of the display device DD4 may include a quarter-wave plate QW and a linear polarizer LL disposed on the quarter-wave plate QW, but not limited thereto. In other words, the quarter-wave plate QW is disposed on the display DP, and the linear polarizer LL is disposed on the quarter-wave plate QW. The linear polarizer LL may have a polarizing direction AR5, which may be parallel to the extending direction (i.e., the direction AR2 mentioned above) of the lens array LA (or the lens unit LN), or parallel to the extending direction of the optical axis of the lens array LA (or the lens unit LN). Specifically, the included angle between the polarizing direction AR5 and the direction AR2 may range from 0.01 to 3 degrees (i.e., 0.01°<included angle<3°). By disposing the quarter-wave plate QW between the display DP and the linear polarizer LL, the possibility of external light (e.g., ambient light) being reflected by elements (e.g., electrodes) in the display device DD4 and observed by the user may be reduced, thereby improving the display quality of the display device DD4.

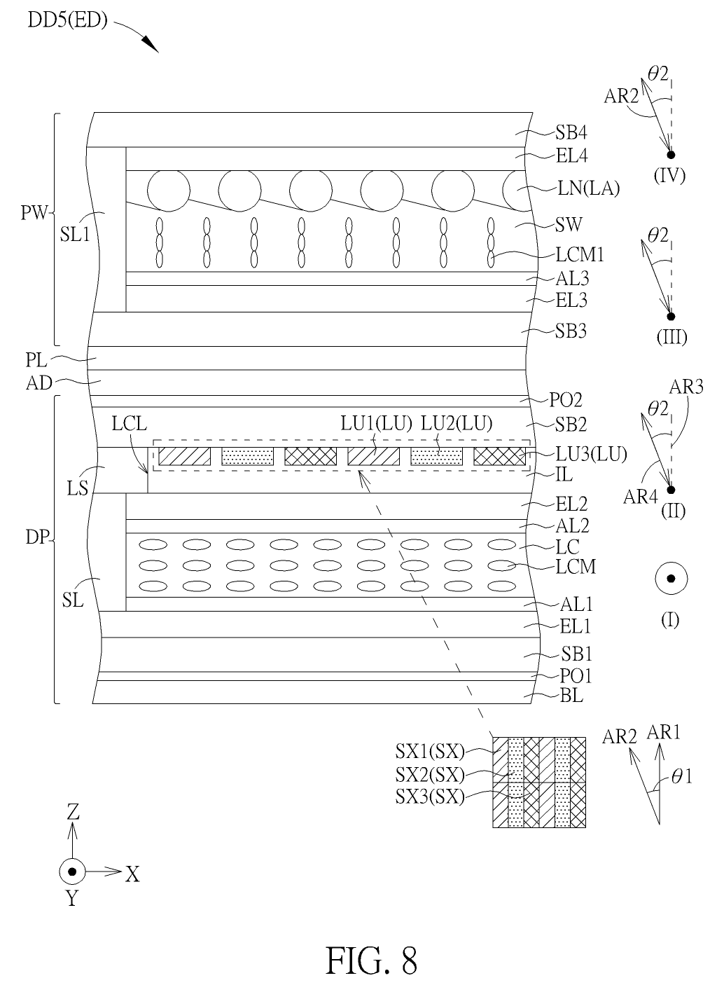

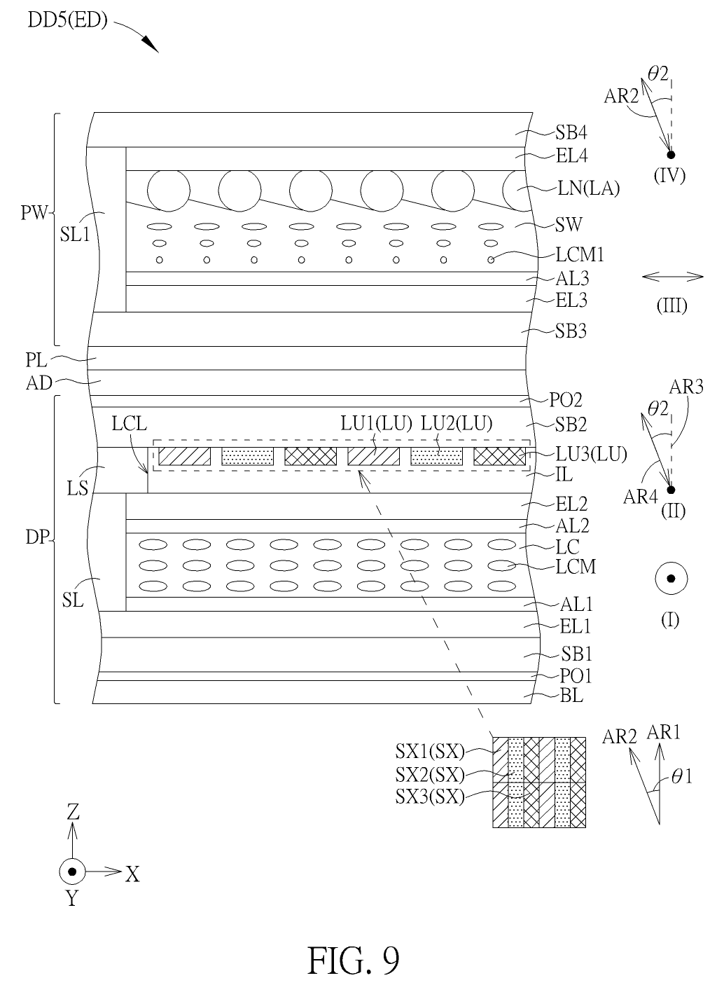

Referring to FIGS. 8 and 9, FIGS. 8 and 9 schematically illustrate a cross-sectional view of an electronic device according to a fifth embodiment of the present disclosure. Specifically, FIGS. 8 and 9 respectively illustrate the display device DD5 operating in the 2D display mode and the 3D display mode. One of the main differences between the display device DD5 of the present embodiment and the display device DD shown in FIG. 1 is the disposition position of the lens array LA. According to the present embodiment, in the display device DD5, the lens array LA may be disposed in the polarization switching unit PW. Specifically, as shown in FIG. 8, the lens array may be disposed on the polarization switching medium SW, for example, between the polarization switching medium SW and the electrode EL4, but not limited thereto. In this case, the display device DD5 may not include the birefringent unit BU mentioned above. In addition, the polarization switching unit PW of the display device DD5 may not include the alignment layer AL4 mentioned above. In the present embodiment, at least one of the refractive indexes (including the extraordinary refractive index ne and the ordinary refractive index no) of the polarization switching medium SW may be equal to the refractive index of the lens unit LN, depending on the design of the display device DD5. Therefore, the polarizing direction of light may match or not match the extending direction of the optical axis of the lens unit LN through the polarization switching medium SW. The structures of the display DP, the polarizing unit PL, and the polarization switching unit PW in the display device DD5 may refer to FIG. 1 and the contents above, and will not be redundantly described. The relationship among the polarizing direction of the polarizing unit PL, the extending direction (i.e., the direction AR2) of the lens unit LN (or the optical axis of the lens unit LN), and the arrangement direction (i.e., the direction AR1) of the sub-pixels SX may refer to the contents in the first embodiment described above, and will not be redundantly described.

As shown in FIG. 8, after passing through the polarizing unit PO2 having a polarizing direction AR3 (e.g., parallel to the direction Y), the light may have the polarization state shown in state (I), that is, the polarizing direction thereof may be parallel to the direction Y. After that, after passing through the polarizing unit PL, the polarization state of the light may change to that shown in state (II), that is, the polarizing direction thereof may be parallel to the polarizing direction AR4 of the polarizing unit PL, and may also be parallel to the extending direction of the lens unit LN. In this case, when the polarization switching medium SW does not change the polarizing direction of the light entering the polarization switching unit PW, the polarizing direction of the light after passing through the polarization switching medium SW may be parallel to the extending direction of the lens unit LN (as shown in state (III) of FIG. 8), such that the light does not refract when entering the lens array LA, thereby displaying 2D images. On the other hand, as shown in FIG. 9, when the polarization switching medium SW changes the polarizing direction of the light entering the polarization switching unit PW, the polarizing direction of the light after passing through the polarization switching medium SW (e.g., parallel to the direction X, as shown in state (III) of FIG. 9) may not be parallel to the extending direction of the lens unit LN, causing the light to refract when entering the lens array LA, thereby displaying 3D images. Other features not mentioned in FIGS. 8 and 9 may refer to FIG. 1, FIG. 2 and the contents above, and will not be redundantly described.

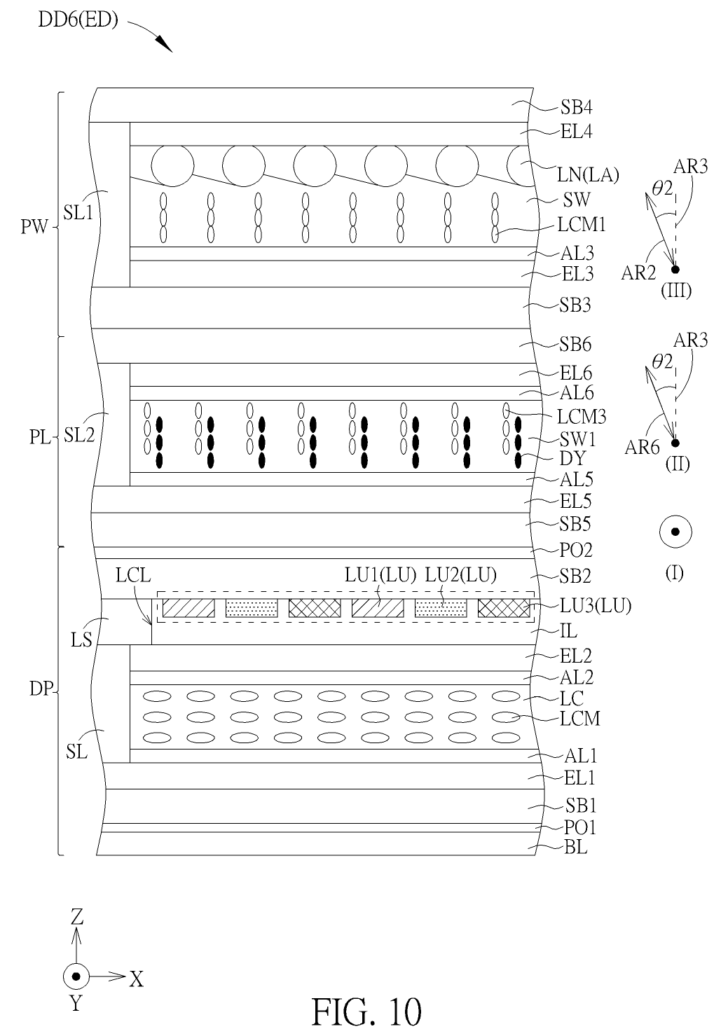

Referring to FIG. 10, FIG. 10 schematically illustrates a cross-sectional view of an electronic device according to a sixth embodiment of the present disclosure. One of the main differences between the display device DD6 of the present embodiment and the display device DD5 shown in FIG. 8 is the design of the polarizing unit PL. Specifically, the polarizing unit PL may include a substrate SB5, a substrate SB6, and an electrode EL5, an alignment layer AL5, a polarization switching medium SW1, an alignment layer AL6, and an electrode EL6 disposed between the substrate SB5 and the substrate SB6. In the present embodiment, the polarization switching medium SW1 may include liquid crystal molecules LCM3 and dye molecules DY, wherein the liquid crystal molecules LCM3 and the dye molecules DY may be used to change the polarization state or polarizing direction of light entering the polarization switching medium SW1. According to the present embodiment, the polarizing direction of the polarizing unit PL may be parallel to the extending direction of the lens unit LN, or in other words, the polarizing direction of the polarization switching medium SW1 may be parallel to the extending direction of the lens unit LN. For example, as shown in FIG. 10, the polarizing direction AR6 of the polarization switching medium SW1 (as shown in state (II)) may be parallel to the extending direction of the lens unit LN (i.e., the direction AR2, as shown in state (III)), and both the polarizing direction AR6 and the direction AR2 may form an included angle θ2 with the polarizing direction AR3 (e.g., parallel to the direction Y) of the polarizing unit PO2 of the display DP. Therefore, after passing through the polarizing unit PL, the polarization state of the light may change from state (I) to state (II), that is, the polarizing direction of the light is parallel to the extending direction of the lens unit LN. When the light passes through the polarization switching unit PW without changing its polarization state, the light may enter the lens array LA without refraction, thereby displaying 2D images. The structures of the display DP and the polarization switching unit PW in FIG. 10, as well as the operation of the display device DD6, may refer to FIGS. 8-9 and the contents above, and will not be redundantly described.

In summary, the present disclosure provides an electronic device, which includes a display, a polarization switching unit disposed on the display, and a lens array. The polarization switching unit is configured to switch the polarizing direction of light, thereby enabling the light to display a 2D image or a 3D image after passing through the lens array. According to the present disclosure, the arrangement direction of the lens array in the electronic device may be not parallel to the arrangement direction of sub-pixels in the display, thereby reducing the occurrence of moiré patterns. In addition, the electronic device may further include a polarizing unit disposed between the display and the polarization switching unit, wherein the polarizing unit is configured to change the polarizing direction of light, thereby improving the display quality of the electronic device in a 2D display mode.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A display device capable of displaying two dimensional images or three dimensional images according to display requirements, comprising:
a display used to provide a display image, wherein the display comprises a first polarizing unit, and the first polarizing unit has a first polarizing direction;
a second polarizing unit disposed on the first polarizing unit and having a second polarizing direction;
a polarization switching unit disposed on the second polarizing unit and comprising a polarization switching medium, wherein a polarization state of the polarization switching medium can be changed by switching voltage; and
a lens array disposed on the second polarizing unit,
wherein an included angle is between the first polarizing direction and the second polarizing direction, and the included angle ranges from 5 to 20 degrees.

2. The display device of claim 1, wherein the polarization switching unit comprises:
a first substrate;
a first electrode located on the first substrate;
a second electrode located on the first electrode; and
a second substrate located on the second electrode,
wherein the polarization switching medium is located between the first electrode and the second electrode.

3. The display device of claim 2, wherein the lens array is disposed in the polarization switching unit.

4. The display device of claim 3, wherein the lens array is disposed between the polarization switching medium and the second electrode.

5. The display device of claim 2, wherein the lens array is disposed on the polarization switching unit.

6. The display device of claim 5, further comprising:
a third substrate located on the polarization switching unit;
a fourth substrate located on the third substrate; and
a birefringent material disposed between the third substrate and the fourth substrate;
wherein the lens array is disposed between the fourth substrate and the birefringent material.

7. The display device of claim 6, wherein at least one of refractive indexes of the birefringent material is equal to a refractive index of the lens array.

8. The display device of claim 1, wherein the second polarizing unit comprises a polarizer, a reflective polarizer or a half-wave plate.

9. The display device of claim 1, wherein the display comprises a first sub-pixel, a second sub-pixel and a third sub-pixel, the first sub-pixel, the second sub-pixel and the third sub-pixel are sub-pixels of different colors, the second polarizing unit comprises a first portion, a second portion and a third portion respectively corresponding to the first sub-pixel, the second sub-pixel and the third sub-pixel, and a thickness of the first portion, a thickness of the second portion and a thickness of the third portion are different from each other.

10. A display device capable of displaying two dimensional images or three dimensional images according to display requirements, comprising:
a display used to provide a display image;
a quarter-wave plate disposed on the display;
a linear polarizer disposed on the quarter-wave plate, wherein the linear polarizer has a first polarizing direction;
a polarization switching unit disposed on the linear polarizer and comprising a polarization switching medium, wherein a polarization state of the polarization switching medium can be changed by switching voltage; and
a lens array disposed on the linear polarizer and having an optical axis extending in a first direction;
wherein the first polarizing direction is parallel to the first direction.
